(19) United States
(12) Patent Application Publication
(10) Pub. No.: US 2011/0146654 A1
(43) Pub. Date: Jun. 23, 2011

(54) LIMITED LOAD HINGE FOR FREESTANDING APPLIANCE

(75) Inventors: SHANTHKUMAR BASAVALINGAPPA MUDBASAL, PUNE (IN); PRASHANT RUPEREE, PUNE (IN); AMANDEEP SINGH, PUNE (IN)

(73) Assignee: WHIRLPOOL CORPORATION, BENTON HARBOR, MI (US)

(21) Appl. No.: 12/643,052

(22) Filed: Dec. 21, 2009

(51) Int. Cl. E05F 5/08; E05D 11/00; E05D 7/00; F24C 15/02

(52) U.S. Cl. 126/194; 16/222

(57) ABSTRACT

A home appliance includes an oven and a door positioned at the front of the oven. A hinge assembly secured to the door is configured to move the door about an axis relative to the front of the oven. The hinge assembly includes a shear pin and a spring configured to exert a shear force. The shear force exerted by the helical spring increases as the door is moved about the first axis, and the shear pin is configured to fracture when the door is moved to a predetermined position about the axis.

### CROSS-REFERENCE TO RELATED U.S. PATENT APPLICATIONS

Cross-reference is made to co-pending U.S. Utility patent application Ser. No. ______ entitled “Load Limiting Hinge with A Spring Loaded Gate For Freestanding Appliance,” which was filed by Prashant Ruperee et al. Attorney Docket No. US20090566 and co-pending U.S. Utility patent application Ser. No. ______ entitled “Hydraulic Hinge For Freestanding Appliance,” which was filed by Prashant Ruperee Attorney Docket No. US20090565, each of which is assigned to the same assignee as the present application, each of which is filed concurrently herewith, and each of which is hereby incorporated by reference.

### TECHNICAL FIELD

The present disclosure relates generally to a freestanding home appliance, and more particularly to door hinges for a freestanding home appliance.

### BACKGROUND

A cooking range is one type of freestanding home appliance. Cooking ranges are used to cook meals and other foodstuffs on a cooking surface or within an oven. A hinged door provides user-access to the oven.

### SUMMARY

According to one aspect, a home appliance includes an oven, a door positioned at the front of the oven, and a hinge housing secured to the door and pivotably coupled to the oven. The hinge housing is configured to move the door about a first axis. The home appliance also includes a rod pivotably coupled to the oven at a first end. The rod has a second end spaced apart from the first end. A shear pin secures a collar to the second end of the rod, and a helical spring is compressed between the collar and the hinge housing. The helical spring is configured to exert a shear force on the collar and the shear pin. The shear force exerted by the helical spring is increased as the door is moved about the first axis, and the shear pin is configured to fracture when the door is moved to a predetermined position about the first axis.

In some embodiments, the door may be moved to the predetermined position when a load exceeding a predefined overload threshold is applied to the door.

In some embodiments, the home appliance may further include a lower frame having a number of downwardly extending legs configured to contact a floor and a housing extending upwardly from the lower frame. The housing may have the oven secured thereto and a mounting slot positioned adjacent to the oven. The home appliance may also include a hinge plate extending from a first end to a second end. The first end may be received in the mounting slot and the second end may be pivotably coupled to a lower end of the hinge housing at a first pivot joint. The first pivot joint may have the first axis extending therethrough.

In some embodiments, the door may be moved into contact with the floor upon fracturing of the shear pin. In some embodiments, the first end of the rod may be pivotably coupled to the second end of the hinge plate at a second pivot joint spaced apart from the first pivot joint. The second pivot joint may have a second axis extending therethrough parallel to the first axis. Additionally, in some embodiments, the rod may be pivoted about the second axis as the door is moved about the first axis.

In some embodiments, the rod may extend outwardly from an upper end of the hinge housing such that the second end of the rod is positioned outside of the hinge housing. The second end of the rod may be moved toward the upper end of the hinge housing as the door is moved about the first axis.

In some embodiments, when the second end of the rod is moved toward the upper end of the hinge housing, the helical spring may be additionally compressed between the collar and the upper end of the hinge housing. In some embodiments, the rod may be configured to pivot about a second axis extending parallel to the first axis, and the pivoting of the rod about the second axis may cause the second end of the rod to move in relation to the upper end of the hinge housing.

According to another aspect, the home appliance includes an oven, a door positioned at the front of the oven, and a hinge housing secured to the door at an upper end and pivotably coupled to the oven at a lower end. The hinge housing is configured to move the door about a first axis, and a rod is moveably coupled to the hinge housing. A shear pin secures a collar to the rod. The shear pin is configured to fracture when a predefined shear force is applied to the collar, and a helical spring extends between the collar and the upper end of the hinge housing. The helical spring is configured to exert a shear force on the collar and the shear pin. When the door is moved to a predetermined position about the first axis, the helical spring exerts the predefined shear force on the shear pin.

In some embodiments, the fracturing of the shear pin may allow the door to move freely about the first axis. In some embodiments, the door may be moved to the predetermined position when a load exceeding a predefined overload threshold is applied to the door. Additionally, in some embodiments, an angle may be defined between the door and the front of the oven as the door is moved about the first axis, and the angle may be greater than 90° when the door is moved to the predetermined position.

In some embodiments, the rod may be configured to retract into the hinge housing when movement of the door about the first axis causes the angle defined between the door and the front of the oven to increase. Additionally, in some embodiments, the rod may be configured to pivot about a second axis extending parallel to the first axis as the door is moved about the first axis, and the pivoting of the rod about the second axis may cause the rod to retract into the hinge housing as the angle defined between the door and the front of the oven is increased.

In some embodiments, the retraction of the rod into the hinge housing may cause the helical spring to compress between the collar and the upper end of the hinge housing.

According to another aspect, the home appliance includes a housing, an oven secured to the housing, a door positioned at the front of the oven, and a hinge assembly configured to move the door about an axis. The hinge assembly includes a hinge housing secured to the door and pivotably coupled to the housing, and a rod pivotably coupled to the housing. The rod extends outwardly from an upper end of the hinge housing. A shear pin secures a collar to the rod, and a helical spring is positioned between the collar and the upper end of the hinge housing. The helical spring is configured to be compressed and exert a shear force on the collar and the shear pin as the door is moved about the axis. When the door is moved to a position where the angle formed between the door and the front of the oven is greater than 90°, the shear pin is configured to fracture from the shear force exerted by the compression of the helical spring.

In some embodiments, the door may moved into contact with the floor upon fracturing of the shear pin. In some embodiments, the hinge assembly may also include a hinge plate secured to the housing. The hinge housing may be pivotably coupled to the hinge plate at a first pivot joint having the axis extending therethrough, and the rod may be pivotably coupled to the hinge plate at a second pivot joint spaced apart from the first pivot joint.

In some embodiments, the door may be moved to the position where the angle formed between the door and the front of the oven is greater than 90° when a load exceeding a predefined overload threshold is applied to the door.

According to another aspect, the home appliance includes an oven, and a door positioned at the front of the oven. The door is configured to rotate about an axis. The home appliance also includes a fluid housing having a cylinder housing with a rod extending therefrom and a relief valve fluidly coupled to the cylinder housing. The relief valve is configured to release fluid from the cylinder housing when fluid pressure in the cylinder housing exceeds a predefined threshold. The fluid pressure within the cylinder housing is increased as the door is moved about the axis, and the fluid pressure in the cylinder housing exceeds the predefined threshold when the door is moved to a predetermined position about the axis.

In some embodiments, the door is moved to the predetermined position when the load applied to the door exceeds a predefined overload threshold. In some embodiments, the cylinder housing may have an inner chamber defined therein containing fluid. The rod may have a first end pivotably coupled to the oven and a second end coupled to a piston positioned within the inner chamber.

In some embodiments, the piston may be moved relative to a wall of the cylinder housing as the door is moved about the axis. In some embodiments, movement of the piston toward the wall of the cylinder housing may cause the fluid pressure in the inner chamber to increase. In some embodiments, the cylinder housing may further include a port fluidly coupled to the inner chamber such that fluid is advanced through the port as the piston is moved toward the wall of the cylinder housing.

In some embodiments, the home appliance may further include an inlet check valve configured to supply fluid from a fluid reservoir to the inner chamber when fluid pressure within the inner chamber is less than fluid pressure in the fluid reservoir. Fluid pressure within the inner chamber may be less than fluid pressure in the fluid reservoir as the piston is moved away from the wall.

In some embodiments, the home appliance may further include an oven housing having a mounting slot positioned adjacent to the oven, a hinge plate extending from a first end received in the mounting slot to a second end positioned external to the oven housing, and a hinge housing secured to the fluid housing. The hinge housing may be pivotably coupled to the hinge plate at a pivot joint, and the pivot joint may have the axis extending therethrough.

In some embodiments, the fluid contained in the cylinder housing may be hydraulic fluid. Additionally, in some embodiments, the fluid contained in the cylinder housing is pressurized air.

According to another aspect, the home appliance includes an oven and a door pivotably coupled to the oven. The door is configured to rotate about a first axis relative to the front of the oven. The home appliance also includes a cylinder housing coupled to the door, and the cylinder housing has an inner chamber defined therein containing fluid. A relief valve is fluidly coupled to the inner chamber. The relief valve is configured to permit fluid to advance from the inner chamber when fluid pressure in the inner chamber exceeds a predefined threshold. The home appliance includes a rod having a first end pivotably coupled to the oven and a second end positioned in the inner chamber. The rod is configured to extend and retract relative to the cylinder housing as the door is rotated about the first axis. The extension of the rod causes fluid pressure in the inner chamber to increase, and fluid pressure exceeds the predefined threshold when the door is moved to a predetermined position about the first axis.

In some embodiments, the second end of the rod may be formed as a piston. Additionally, in some embodiments, the home appliance may include a fluid reservoir fluidly coupled to the relief valve. Fluid may be advanced from the inner chamber to the fluid reservoir when the door is placed in the predetermined position.

In some embodiments, the home appliance may further include an inlet check valve positioned between the inner chamber and the fluid reservoir. The inlet check valve may be configured to permit fluid to be advanced from the fluid reservoir to the inner chamber when fluid pressure within the inner chamber is less than fluid pressure in the fluid reservoir.

In some embodiments, the home appliance may further include a spring positioned between the piston and a wall of the cylinder housing. In such embodiments, the door may be moved to the predetermined position upon application of a load exceeding a predefined threshold, and upon removal of the load, the spring may urge the piston away from the wall of the cylinder housing. Additionally, upon removal of the load, the movement of piston away from the lower wall may cause the fluid pressure in the inner chamber to be less than the fluid pressure in the reservoir.

In some embodiments, the home appliance may further include a hinge plate extending from a first end to a second end. The first end may be secured to the oven and the second end may be pivotably coupled to the door at a first pivot joint having the first axis extending therethrough. Additionally, in some embodiments, the first end of the rod may be pivotably coupled to the second end of the hinge plate at a second pivot joint spaced apart from the first pivot joint. The second pivot joint may have a second axis extending therethrough parallel to the first axis.

In some embodiments, the rod may be pivoted about the second axis as the door is rotated about the first axis.

According to another aspect, the home appliance includes an oven, a door positioned at the front of the oven that is configured to rotate about an axis, and a fluid housing having a cylinder housing with a rod extending therefrom. The home appliance also includes a relief valve fluidly coupled to the cylinder housing. The relief valve is configured to release fluid from the cylinder housing when fluid pressure in the cylinder housing exceeds a predefined threshold. An angle is defined between the door and the front of the oven as the door is rotated about the axis. When the angle is greater than 90°, the fluid pressure in the cylindrical housing exceeds the predefined threshold.

In some embodiments, the door is moved to a position at which the angle is greater than 90° upon application of a load exceeding a predefined threshold.

According to another aspect, a home appliance includes an oven, a door positioned at the front of the oven, and a hinge assembly configured to move the door about a first axis. The hinge assembly includes a hinge housing secured to the door at a first end and pivotably coupled to the oven at a second end. The hinge housing has a slot extending in a direction perpendicular to the first axis. A follower is positioned within the slot and moveable between a first end and a second end of the slot, and a rod is pivotably coupled to the oven and the follower. A moveable gateway is positioned adjacent to the first end of the slot. The gateway is biased in a closed position to prevent movement of the follower toward the first end of the slot. When the door is rotated to a predetermined position, the gateway is moved to an open position such that movement of the follower toward the first end of the slot is permitted.

In some embodiments, the hinge assembly may further include a spring having a first end secured to the gateway and a second end secured to the door, and the spring may bias the gateway in the closed position. In some embodiments, when the door is rotated to the predetermined position the spring may be compressed such that the gateway is moved to the open position.

In some embodiments, the hinge housing may be pivotably coupled to the oven at a first pivot joint defining the first axis, and the movement of the hinge housing about the first axis may cause the rotation of the door relative to the front of the oven. In some embodiments, the rod may be pivotably coupled to the oven at a second pivot joint defining a second axis, and the movement of the hinge housing about the first axis may cause the rod to move about the second axis.

In some embodiments, movement of the hinge housing about the first axis may cause the follower to move within the slot. In some embodiments, the gateway may include a first gate and a second gate positioned within a track extending perpendicular to the slot. The first gate may be configured to move along the track in a first direction, and the second gate may be configured to move along the track in a second direction opposite the first direction.

Additionally, in some embodiments, when the gateway is positioned in the closed position, the first gate may contact the second gate. In some embodiments, the first gate may extend from a tip configured to contact the second gate to a base having a first spring secured thereto and the second gate may extend from a tip configured to contact the second gate to a base having a second spring secured thereto. The first spring and the second spring may bias the first gate into contact with the second gate such that the gateway is positioned in the closed position. In some embodiments, when the door is rotated to the predetermined position, the first gate may be moved in the first direction, the second gate may be moved in the second direction, and the follower may be positioned between the first gate and the second gate.

According to another aspect, the home appliance includes an oven, a door pivotably coupled to the oven that is configured to rotate relative to the front of the oven about a first axis, and a rod pivotably coupled to the oven and having a pin secured thereto. The pin is configured to move along a second axis extending perpendicular to the first axis as the door is rotated about the first axis. A first gate is positioned along the second axis, and a second gate is positioned along the second axis opposite the first gate and contacting the first gate to prevent movement of the pin along the second axis. When the door is rotated to a predetermined position about the first axis, the first gate and the second gate are moved apart such that movement of the pin along the second axis is permitted.

In some embodiments, the home appliance may include a lower frame having a number of downwardly extending legs configured to contact a floor, a housing extending upwardly from the lower frame that has the oven secured thereto and a mounting slot positioned adjacent to the opening of the oven, and a hinge plate extending from a first end to a second end. The first end may be received in the mounting slot and the second end may be pivotably coupled to the door at a first pivot joint. The first pivot joint may define the first axis.

In some embodiments, the rod may be pivotably coupled to the hinge plate at a second pivot joint.

According to another aspect, a home appliance includes an oven, a door pivotably coupled to the oven that is configured to rotate relative to the front of the oven about a first axis, and a housing secured to the door. The housing has a slot defined therein that has a longitudinal axis extending in a direction perpendicular to the first axis. A rod is pivotably coupled to the oven that has a pin extending therefrom positioned within the slot and moveable along the longitudinal axis of the slot. A first gate is positioned along the longitudinal axis of the slot, and a second gate is positioned along the longitudinal axis of the slot opposite the first gate and contacting the first gate to prevent movement of the pin toward an end of the slot. An angle is defined between the door and the front of the oven as the door is rotated about the first axis. When the angle is greater than 90°, the first gate and the second gate are moved apart such that movement of the pin toward the end of the slot is permitted.

In some embodiments, when the angle defined between the door and the front of the oven is approximately equal to 90°, the pin may be placed in contact with the first gate and the second gate. In some embodiments, the first gate may be positioned within a track extending perpendicular to the slot and may be configured to move along the track in a first direction when moved apart from the second gate, and the second gate may be positioned within the track and may be configured to move along the track in a second direction opposite the first direction when moved apart from the first gate.

In some embodiments, the housing may have a first end coupled to the door and a second end pivotably coupled to the oven at a first pivot joint defining the first axis. Movement of the hinge housing about the first axis may cause the rotation of the door relative to the front of the oven.

### BRIEF DESCRIPTION OF THE DRAWINGS

The detailed description particularly refers to the following figures, in which:

FIG. 1 is a perspective view of a domestic cooking range;

FIG. 2 is an exploded perspective view of one embodiment of a hinge assembly of the cooking range of FIG. 1;

FIG. 3 is a fragmentary elevation view of the hinge assembly of FIG. 2;

FIGS. 4-6 are diagrammatic views of the cooking range of FIG. 1 showing the oven door throughout its range of motion;

FIG. 7 is a perspective view of another embodiment of a hinge assembly of the cooking range of FIG. 1;

FIGS. 8-10 are fragmentary elevation views of the hinge assembly of FIG. 7 showing the position of the piston within the cylinder housing at several oven door positions;

FIG. 11 is a perspective view of another embodiment of a hinge assembly of the cooking range of FIG. 1; and

FIGS. 12-14 are fragmentary elevation views of the hinge assembly of FIG. 11 showing the position of the hinge gateway at several oven door positions.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

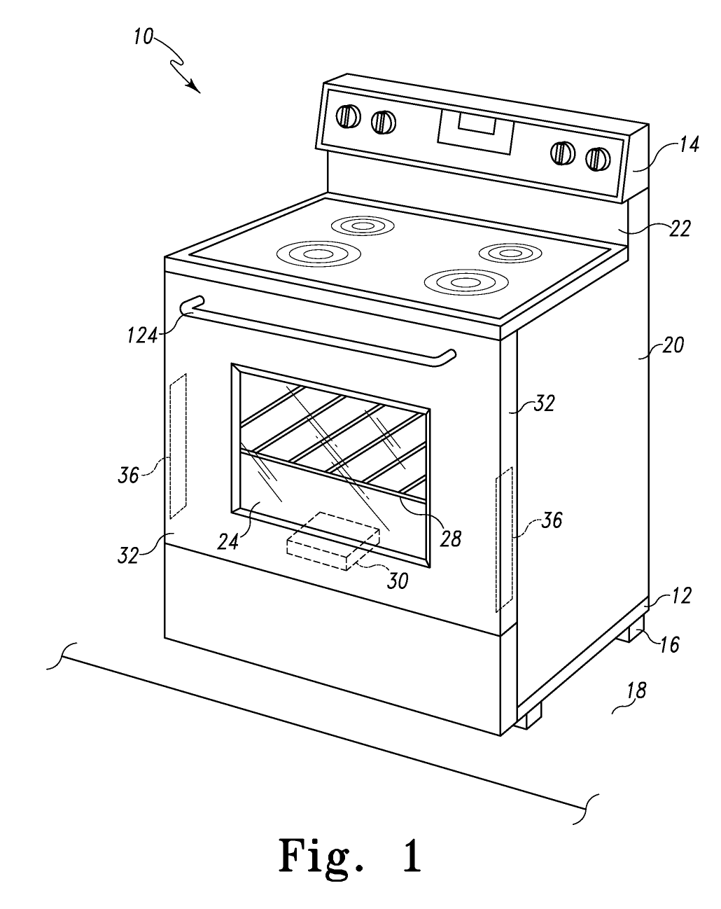

Referring to FIG. 1, a freestanding home appliance is shown as a domestic cooking range assembly 10 (hereinafter range 10). The range 10 includes a lower frame 12 and an upper panel 14. The lower frame 12 has a number of downwardly extending legs 16 configured to contact a floor 18 of a house. The legs 16 are located in each corner of the lower frame 12 and are adjustable to allow the user to level the range 10 to compensate for any tilt or angle of the floor 18.

A housing 20 extends upwardly from the lower frame 12. The upper panel 14 has a laterally extending base 22 that is secured to the housing 20. The housing 20 includes an oven 24 into which pans, sheets, or other cookware are placed to be heated. The oven 24 has a rack 28 positioned therein above a baking element 30 that is configured to provide heat for baking or otherwise cooking food items placed on the rack 28. In the illustrative embodiment, the baking element 30 is an electric heating element. It should be appreciated that in other embodiments the baking element 30 may be a gas-fired heating element.

An oven door 32 is hinged to the front of the housing 20 via a pair of hinge assemblies 36. User-access to the rack 28 positioned in the oven 24 is provided through an access opening, and the door 32 is configured to permit or prevent that user-access. As such, when the door 32 is closed, user-access to the rack 28 is prevented, whereas user-access to the rack 28 is permitted when the door 32 is open.

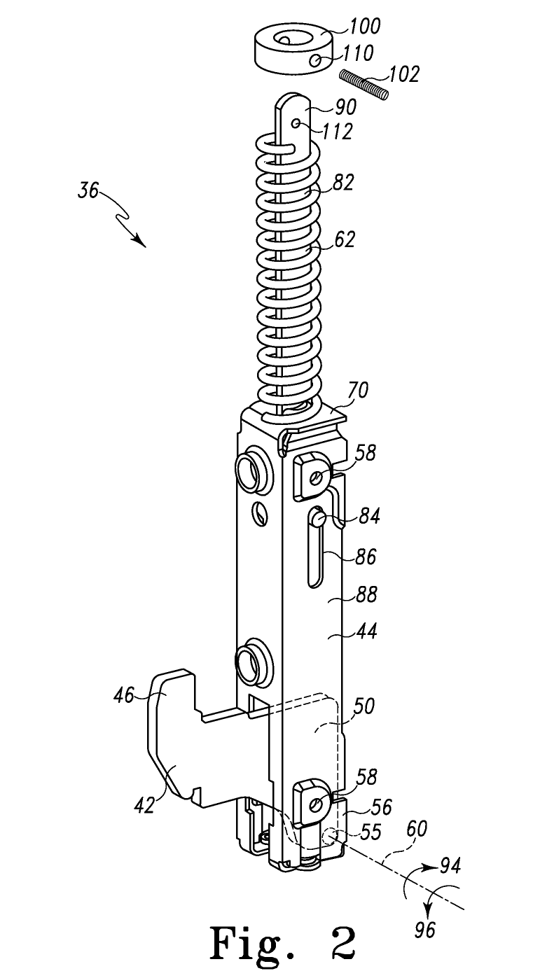

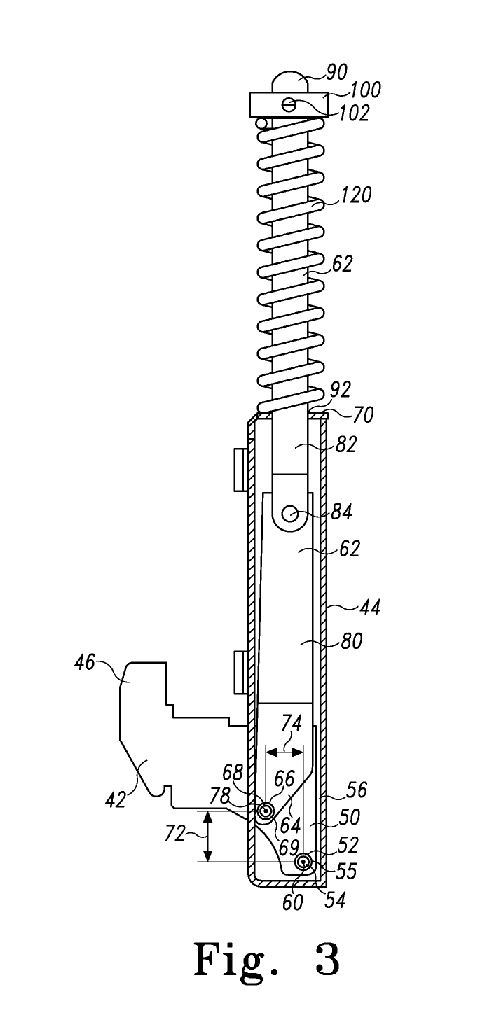

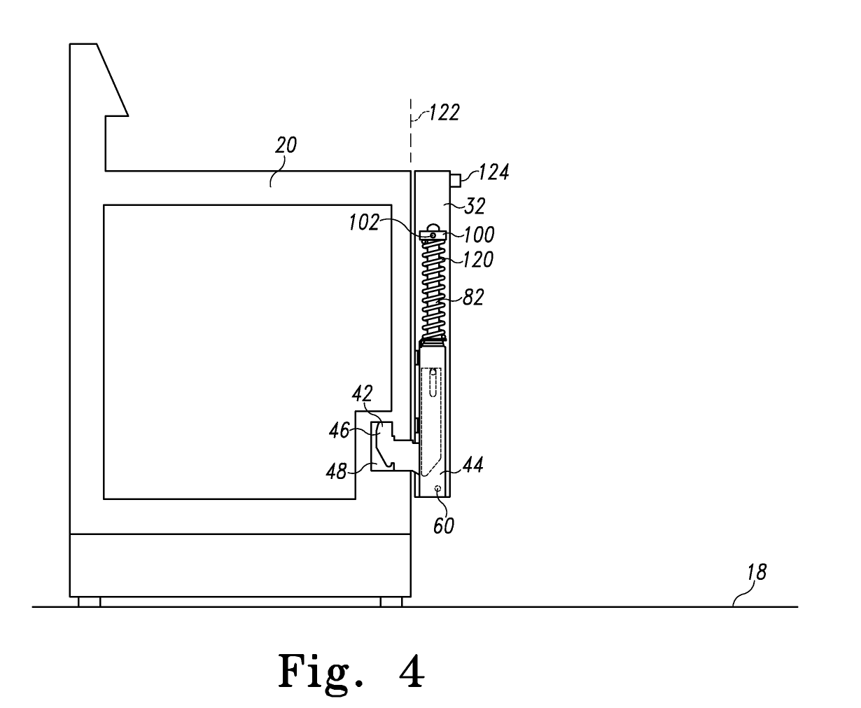

Referring now to FIGS. 2 and 3, one of the hinge assemblies 36 is shown in greater detail. The hinge assembly 36 includes a hinge plate 42 and a hinge housing 44. As shown in FIGS. 4-6, the hinge plate 42 has a latching end 46 extending out of the hinge housing 44 and is secured in a slot 48 formed in the housing 20 of the range 10. A mounting end 50 of the hinge plate 42 is coupled to the hinge housing 44 at a pivot joint 52 (see FIG. 3). Specifically, the pivot joint 52 includes a cylindrical pivot pin 54 that extends through, and is positioned in, a pair of holes 55 defined in both a lower end 56 of the hinge housing 44 and the mounting end 50 of the hinge plate 42.

The hinge housing 44 has a number of apertures 58 formed therein, each of which receives a bolt (not shown) to secure the hinge housing 44 to the oven door 32. As such, when the oven door 32 is opened or closed by a user, the hinge housing 44 (and hence the door 32) pivots relative to the front of the oven 24 about an axis 60 defined by the pivot joint 52.

The hinge assembly 36 also includes a two-piece rod 62 pivotably coupled at a lower end 64 to the mounting end 50 of the hinge plate 42 at a pivot joint 66. As shown in FIG. 3, the pivot joint 66 is spaced apart vertically from the pivot joint 52 by a distance 72 and spaced apart horizontally from the pivot joint 52 by a distance 74 that is less than the distance 72. The pivot joint 66 includes a cylindrical pivot pin 68 that extends through, and is positioned in, a pair of holes 69 defined in both the lower end 64 of the rod 62 and the mounting end 50 of the hinge plate 42. As will be described below in greater detail, when the door 32 is opened or closed by a user, the lower end 64 of the rod 62 pivots relative to the hinge plate 42 about an axis 78 defined by the pivot joint 66.

The two-piece rod 62 includes a transfer linkage 80 pivotably coupled to a slide linkage 82 via a pin 84. The pin 84 extends out of the hinge housing 44 through a slot 86 formed in a sidewall 88 thereof (see FIG. 2). The size of the slot 86 corresponds closely with the size of the pin 84 such that the pin 84 is generally constrained to linear movement relative to the slot 86 as the rod 62 pivots about the axis 78.

An upper end 90 of the slide linkage 82 extends outwardly from the hinge housing 44 through a slot 92 formed in an upper end 70 thereof. The size of the slot 92 corresponds closely with the size of the slide linkage 82 such that the slide linkage 82 is generally constrained to linear movement relative to slot 92. As such, when the hinge housing 44 is pivoted about the axis 60, the slide linkage 82 (and, hence, rod 62) is forced to pivot about the axis 78.

Because the axes 60, 78 are offset by the distances 72, 74, the movement of the hinge housing 44 and the rod 62 about their respective axes 60, 78 causes the slide linkage 82 to slide back and forth within the slot 92. For example, when the user opens the oven door 32, the hinge housing 44 pivots about the axis 60 in the direction indicated by an arrow 94 (see FIG. 2), and the slide linkage 82 of the rod 62 slides or retracts into the hinge housing 44. The upper end 90 of the slide linkage 82 is thereby moved toward the upper end 70 of the hinge housing 44. Conversely, when the user closes the oven door 32, the hinge housing 44 pivots about the axis 60 in the opposite direction, which is indicated by an arrow 96. The slide linkage 82 of the rod 62 slides or extends out of the hinge housing 44, and the upper end 90 of the slide linkage 82 is thereby moved away from the upper end 70 of the hinge housing 44.

At the upper end 90 of the slide linkage 82, a collar 100 is secured to the slide linkage 82 via a shear pin 102. The shear pin 102 is positioned in a through-hole 110 extending through the collar 100 and a corresponding hole 112 formed in the upper end 90 of the slide linkage 82. The shear pin 102 is configured to fracture when a predefined shear force is applied to the collar 100. The shear pin 102 is embodied as a metallic set screw that is threaded into the holes 110, 112. It will be appreciated that the shear pin 102 may also take the form of a dowel, bolt, pin, or other fastener.

A helical spring 120 extends over the slide linkage 82 from the upper end 70 of the hinge housing 44 of the collar 100. The spring 120 exerts a biasing force on the hinge housing 44 and the collar 100. Because the slide linkage 82 is secured to the collar 100 via the shear pin 102, the biasing force counteracts the movement of the slide linkage 82 within the hinge housing 44 and thereby resists the pivoting of the hinge housing 44 (and, hence, the door 32) about the axis 60. The spring 120 is sized such that it exerts a biasing force sufficient to counter the weight of the door 32 at various positions about the axis 60.

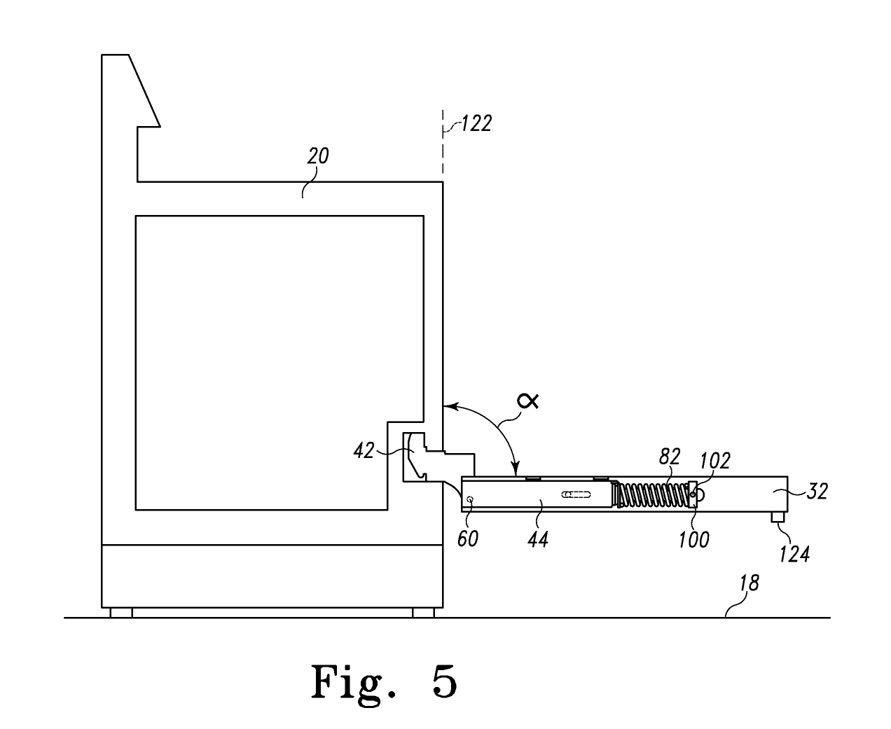

Referring now to FIGS. 4-6, one of the hinge assemblies 36 is illustrated in diagrammatic form. As discussed above, each of the hinge assemblies 36 is configured to permit movement of the door 32 between plurality of positions about the axis 60. Those positions include a closed position (see, e.g., FIG. 4) and an open position (see, e.g., FIG. 5). In each position about the axis 60, an angle a is defined between the door 32 and an imaginary vertical plane 122 defining the front of the oven 24. As shown in FIG. 5, the angle a is approximately ninety degrees, or, said another way, the door 32 is open approximately ninety degrees.

The spring 120 is sized such that it exerts a biasing force sufficient to counter the weight of the door 32 when the door 32 is open at any position where the angle α is less than ninety degrees. For example, when the door 32 is closed (see FIG. 4), the biasing force acts to maintain the door 32 in that position. By applying an external load, the user may move the door 32 about the axis 60.

In particular, by using a handle 124 located on the front of the door 32, the user may apply the external load necessary to overcome the biasing force exerted by the spring 120. When the user pulls on the handle 124, the movement of the door 32 (and therefore hinge housing 44) about the axis 60 causes the rod 62 (and hence transfer linkage 80) to pivot about the axis 78. As the transfer linkage 80 of the rod 62 is pivoted, the slide linkage 82 is retracted into the hinge housing 44, thereby urging the collar 100 toward the upper end 70 of the hinge housing 44. The movement of the collar 100 compresses the spring 120, thereby causing the biasing force exerted by the spring 120 to increase. When the user releases the handle 124 at a particular position, the spring 120 exerts a biasing force sufficient to counter the weight of the door 32 such that the hinge assembly 36 maintains the door 32 in that position. For example, as shown in FIG. 5, the door 32 is held open when no external force is applied.

To move the door 32 open beyond ninety degrees, the user must apply a load beyond a predefined overload threshold to the door 32. When such an overload is applied, the biasing force exerted by the spring 120 exceeds the predefined shear force of the shear pin 102, thereby causing the shear pin 102 to fracture. As shown in FIG. 6, the fracturing of the shear pin 102 releases the collar 100 from the slide linkage 82. As a result, the spring 120 is unable to counteract the movement of the slide linkage 82 within the hinge housing 44, and the hinge assembly 36 is unable to exert the force necessary maintain the door 32 in position. It will be appreciated that should the shear pins 102 of both hinge assemblies 36 fracture at the same time, the weight of the door 32 will cause the door 32 to move downward into contact with the floor 18.

As will be appreciated by those of the skill in the art, the range 10 may include elements other than those shown and described above, such as, by way of example, an additional shear pin to distribute the shear force to multiple pins or an additional oven to allow the user to cook multiple foodstuffs at different temperatures. It should also be appreciated that many of the components may be altered, such as, for example, the shear pin 102 may take the form of a bolt, dowel rod, pin, or other configuration possessing the required material strength. Additionally, in other embodiments, the physical requirements of the shear pin 102 may also change based on, for example, the size of the range 10. In such embodiments, the shear pin 102 may be resized or formed from different materials such that the shear pin 102 possesses the greater or lesser material strength to fracture at different shear forces generated by the spring 120 depending on the requirements of the particular range 10.

Referring now to FIGS. 7-10, another embodiment of a hinge assembly 36 (hereinafter referenced as a hinge assembly 236) is shown. Some features of the embodiment illustrated in FIGS. 7-10 are substantially similar to those discussed above in reference to the embodiment of FIGS. 1-6. Such features are designated in FIGS. 7-10 with the same reference numbers as those used in FIGS. 1-6. In lieu of a coiled spring assembly, the hinge assembly 236 utilizes a fluid spring assembly 238 to facilitate movement of the oven door 32.

As shown in FIG. 7, the fluid spring assembly 238 includes a cylinder housing 242 secured to the upper end 70 of the hinge housing 44. An upper end 240 of the slide linkage 82 extends through a sealed portal 241 formed in a lower wall 244 of the cylinder housing 242 and into an inner chamber 246 defined therein. Within the chamber 246, a piston 248 is secured to the upper end 240 of the slide linkage 82, and a spring 254 is positioned between the piston 248 and the lower wall 244.

The chamber 246 is filled with fluid between the lower wall 244 and the piston 248. It should be appreciated that a “fluid” may be a liquid, such as hydraulic oil, or some form of gas, such as, for example, air. An outer surface 260 of the piston 248 has a gasket 262 secured thereto that creates a fluid-tight seal between the piston 248 and a sidewall 264 of the cylinder housing 242. In that way, when the piston 248 moves within chamber 246, fluid is prevented from passing between the piston 248 and the sidewall 264.

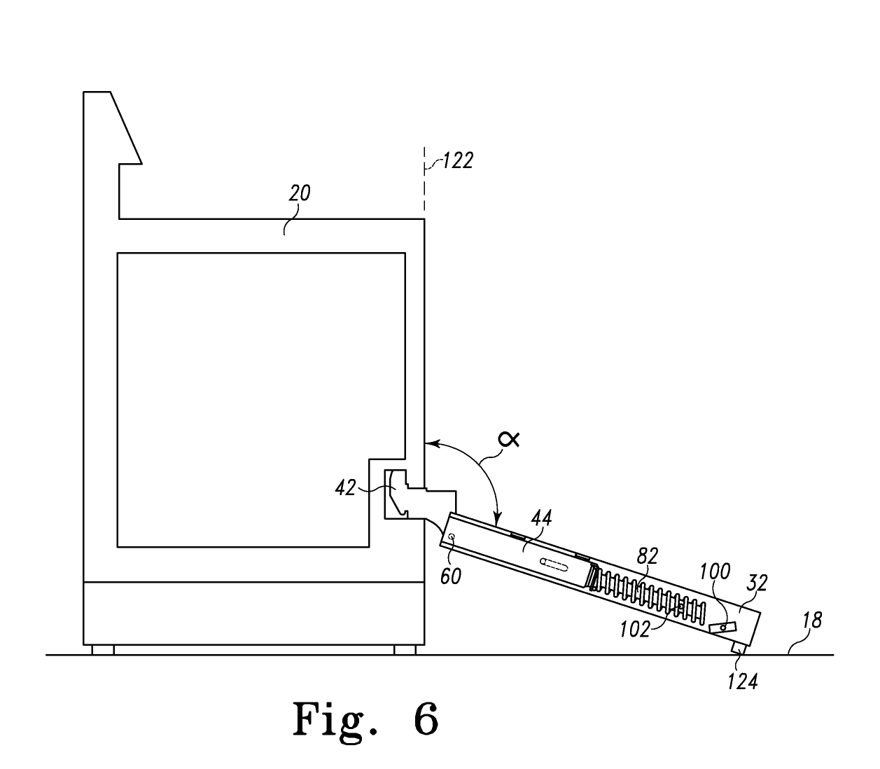

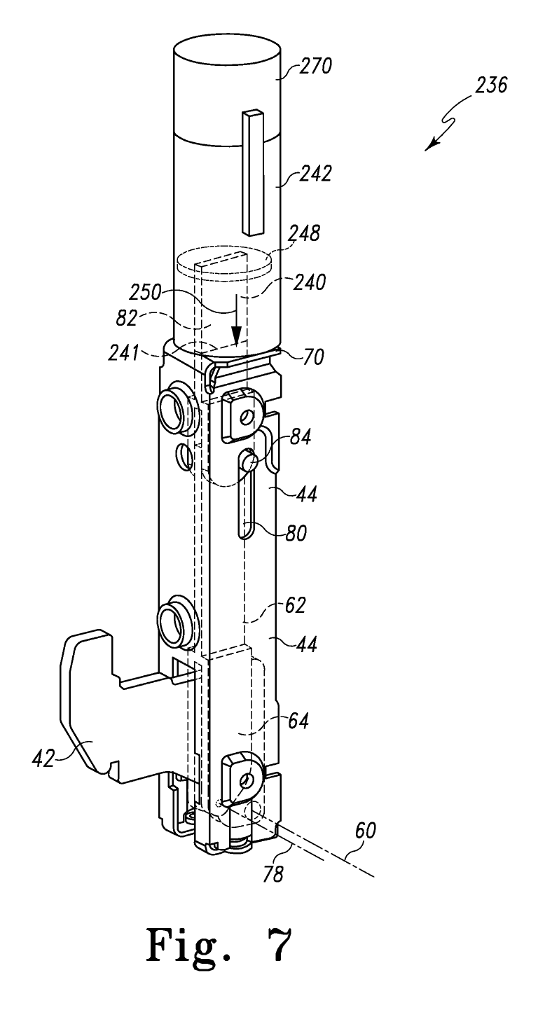

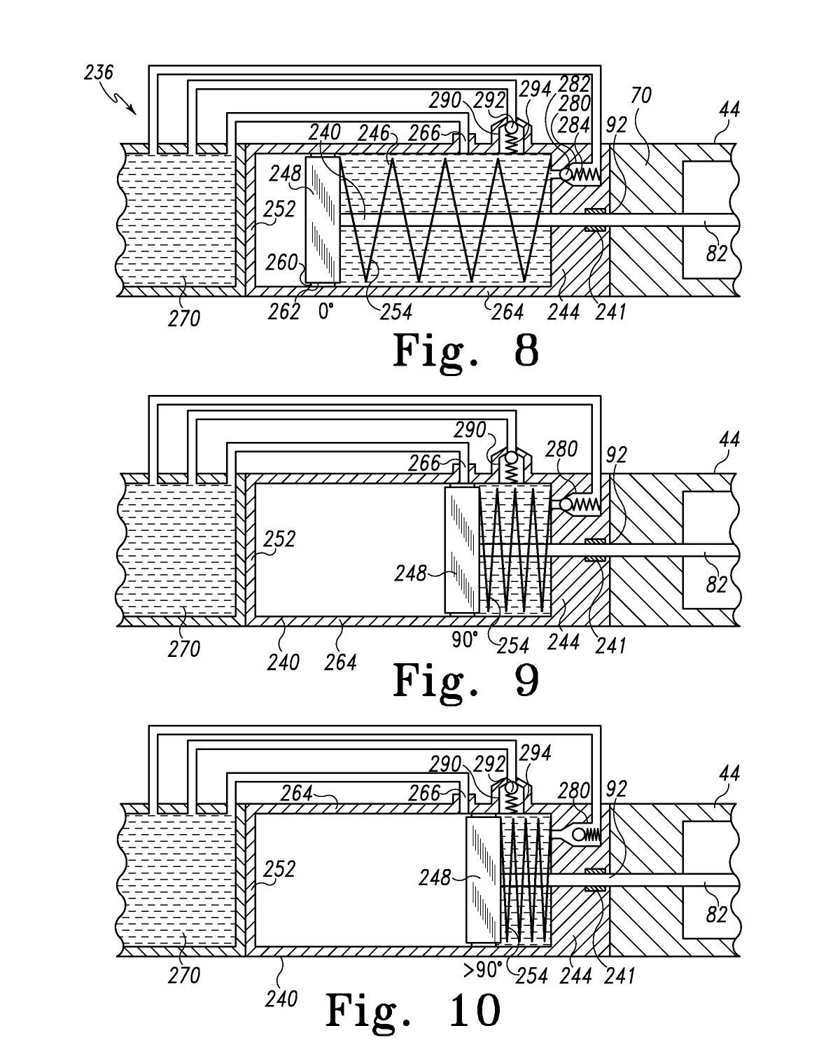

As discussed above in regard to FIGS. 1-6, when the user opens the oven door 32, the hinge housing 44 pivots about the axis 60 and the slide linkage 82 slides into the hinge housing 44. However, as shown in FIGS. 8-10, sliding the slide linkage 82 into the hinge housing 44 results in the slide linkage 82 extending further from the cylinder housing 242. As the slide linkage 82 extends further from the cylinder housing 242, the piston 248 is moved toward the lower wall 244 of the cylinder housing 242. The spring 254 exerts a spring bias that resists the movement of the piston 248 toward the lower wall 244. When the user closes the oven door 32, the slide linkage 82 slides or extends out of the hinge housing 44, thereby moving the piston 248 away from the lower wall 244.

A port 266 extending from the chamber 246 through the sidewall 264 of the cylinder housing 242 fluidly couples the chamber 246 to a fluid reservoir 270. As the user opens the door 32, the piston 248 moves toward the lower wall 244, thereby urging fluid out of the chamber 246 through the port 266 into the reservoir 270. Conversely, when the user closes the door 32, the piston 248 moves away from the lower wall 244 and fluid is permitted to move from the reservoir 270 through the port 266 to the chamber 246. In that way, fluid pressure within the chamber 246 remains relatively constant so long as fluid is free to move in and out of the chamber 246 through the port 266.

As shown in FIGS. 9 and 10, fluid is prevented from advancing through the port 266 when the door 32 is opened at or beyond ninety degrees. When the angle of the door 32 is approximately ninety degrees (see FIG. 9), the piston 248 is positioned over the port 266, thereby preventing fluid from advancing through the port 266. As will be discussed in greater detail below, moving the door 32 beyond ninety degrees causes the fluid pressure within the chamber 246 to increase.

A check valve 280 is positioned between the chamber 246 and the reservoir 270 and is configured to relieve pressure within the chamber 246. The valve 280 includes a valve member 282 having a spring 284 secured thereto. The spring 284 biases the valve member 282 into a closed position. When the fluid pressure within the chamber 246 exceeds a predetermined relief pressure, the bias exerted by the spring 284 is overcome by the pressure acting on the valve member 282 and fluid flows from the chamber 246 to the reservoir 270.

A second check valve 290 is positioned between the chamber 246 and the reservoir 270 and is configured to permit or prevent fluid from moving from the reservoir 270 to the chamber 246. The valve 290 includes a valve member 292 having a spring 294 secured thereto. The spring 294 biases the valve member 292 into a closed position. When the pressure in the chamber 246 is less than the pressure in reservoir 270, the bias exerted by the spring 294 is overcome by the pressure acting on the valve member 292 and fluid flows from the reservoir 270 to the chamber 246.

When the user applies a load that exceeds a predefined overload threshold, the door 32 is moved beyond ninety degrees. The piston 248 moves toward the lower wall 244 of the cylinder housing 242, and, as discussed above, the movement of the piston 248 causes fluid pressure to increase and exceed the predetermined relief pressure. The valve 280 opens in response and fluid exits the chamber 246 through the valve 280.

When the user releases the oven door 32 at a position where the angle of the door 32 is greater than ninety degrees, the spring 254 urges the piston 248 away from the lower wall 244. The movement of the piston 248 causes the door 32 to begin moving back toward a position where the angle defined between the door 32 and the front of the oven is approximately ninety degrees. Additionally, fluid pressure in the chamber 246 decreases as the piston 248 moves away from the lower wall 244, and the valve 280 closes when the fluid pressure drops below the predetermined relief pressure.

When the pressure in the chamber 246 is less than the pressure in the reservoir 270, the valve 290 is opened, and fluid enters the chamber 246 through the open valve 290 until the angle of the door 32 is approximately ninety degrees. At that position, the pressure in the chamber 246 is approximately equal to the pressure in the reservoir 270, and the spring 294 urges the valve 290 closed.

As will be appreciated by those of the skill in the art, hinge 236 may include elements other than those shown and described above, such as, by way of example, an additional port connecting the chamber 246 to the reservoir 270 or an additional piston 248 positioned in the chamber 246. It should also be appreciated that many of the components may be altered, such as, for example, the size of the chamber 246 or the piston 248, or the predetermined relief pressure.

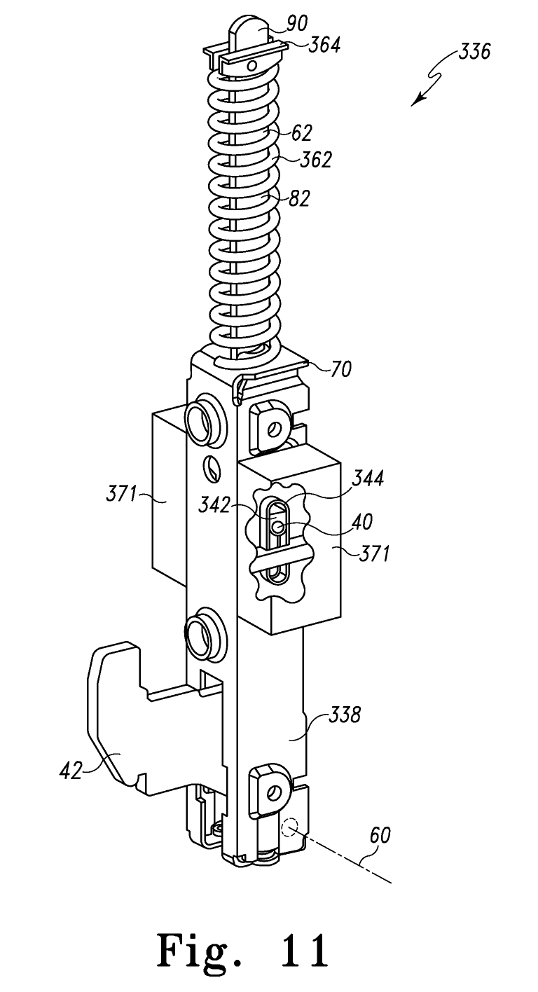

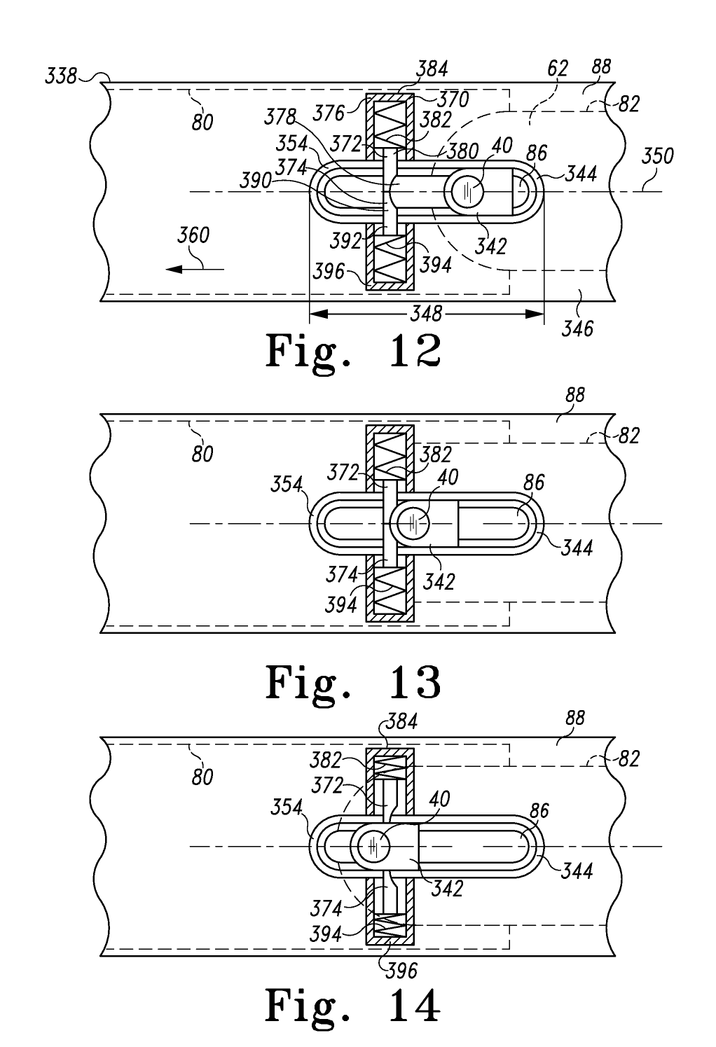

Referring now to FIGS. 11-14, another embodiment of a hinge assembly 36 (hereinafter referenced as a hinge assembly 336) is shown. Some features of the embodiment illustrated in FIGS. 11-14 are substantially similar to those discussed above in reference to the embodiments of FIGS. 1-10. Such features are designated in FIGS. 11-14 with the same reference numbers as those used in FIGS. 1-10. As will be discussed in greater detail below, the hinge assembly 336, like the hinge assemblies 36 and 236, is configured to permit movement of the door 32 between the plurality of positions about the axis 60.

Like the designs of FIGS. 1-10, the linkages 80, 82 of the two-piece rod 62 are pivotably secured to one another via a pin 40. The pin 40 of the hinge assembly 336 extends outwardly from the linkages 80, 82 of the two-piece rod 62 through the slot 86 formed in the sidewall 88 of the hinge housing 338. The pin 40 is received in a follower 342 positioned within another slot 344 extending outwardly from the sidewall 88 of the hinge housing 338. The slot 344 has an axis 350 extending perpendicular to the axes 60, 78. The size of the slots 86, 344 correspond closely with the size of the pin 40 and the follower 342 such that the pin 40 and the follower 342 are generally constrained to linear movement relative to the slots 86, 344.

Returning to FIG. 11, the slide linkage 82 has an upper end 90 that extends outwardly from the hinge housing 338 through a slot (not shown) formed in an upper end 70 thereof. In a manner similar to that discussed above in regard to FIGS. 1-6, the size of the slot corresponds closely with the size of the slide linkage 82 such that the slide linkage 82 is generally constrained to linear movement relative to the slot. As such, when the hinge housing 44 is pivoted about the axis 60, the slide linkage 82 of the rod 62 is forced to pivot about its axis.

Similar to the hinge assembly 36, the movement of the hinge housing 44 and the rod 62 about their respective axes causes the slide linkage 82 to slide back and forth within the hinge housing 338. For example, when the user opens the oven door 32, the hinge housing 338 pivots about the axis 60 and the slide linkage 82 slides or retracts into the hinge housing 338. Retracting the slide linkage 82 into the hinge housing 338 urges the follower 342 toward an end 354 of the slot 344, as indicated by an arrow 360 (see FIG. 12).

A helical spring 362 extends over the slide linkage 82 from an upper end 70 of the hinge housing 338 to a plate 364 formed at the upper end 90 of the slide linkage 82. The spring 362 exerts a biasing force on the hinge housing 338 and the plate 364 that counteracts the movement of the slide linkage 82 within the hinge housing 338 and thereby resists the pivoting of the hinge housing 338 (and, hence, door 32) about the axis 60. The spring 362 is sized such that it exerts a biasing force sufficient to counter the weight of the door 32 at any position where the angle of the door 32 is less than ninety degrees.

When the door 32 is opened such that the angle is approximately ninety degrees, the follower 342 is placed in contact with a gateway mechanism 370 positioned within a casing 371 secured to the hinge housing 338. As shown in FIGS. 12-14, the gateway 370 is positioned near the end 354 of the slot 344. The gateway 370 includes an upper gate 372 and a lower gate 374 positioned in a track 376 extending perpendicular to the axis 350. The upper gate 372 extends from a tip 378 that contacts the lower gate 374 to a base 380. A spring 382 is secured at one end to the base 380 and at the other end to an upper wall 384 of the track 376. The lower gate 374 extends from a tip 390 that contacts the tip 378 of the upper gate 372 to a base 392. A spring 394 is secured at one end to the base 392 of the lower gate 374 and at the other end to a lower wall 396 of the track 376.

The springs 382, 394 bias the upper gate 372 into contact with the lower gate 374 such that the gateway 370 is closed when the follower 342 is placed in contact with the gates 372, 374. The springs 382, 394 are each sized to exert a biasing force that, when combined with the biasing force exerted by the spring 362, is sufficient to counter the weight of the oven door 32 when the angle of the door 32 is approximately ninety degrees. In that way, the gateway 370 prevents further movement of the follower 342 (and hence pin 40) along the slot 344, thereby preventing the slide linkage 82 from retracting and maintaining the door 32 at that open position.

To move the door 32 beyond ninety degrees, the user must apply a load to the door 32 that exceeds a predefined overload threshold. That load is applied through the pin 40 and the follower 342 to the gates 372, 374 to overcome the bias exerted by the springs 382, 394. Consequently, the gates 372, 374 are moved apart, and, as shown in FIG. 14, the upper gate 372 is moved toward the upper wall 384 of the track 376 while the lower gate 374 is moved in the opposite direction toward the lower wall 396. The follower 342 is moved through the open gateway 370 closer to the end 354 of the slot 344, and the door 32 is moved to a position where the angle of the door 32 is greater than ninety degrees. When the angle of the door 32 is returned to ninety degrees, the follower 342 moves away from the end 354, and the springs 382, 394 urge the gates 372, 374 back into contact, thereby closing the gateway 370.

As will be appreciated by those of the skill in the art, the range 10 may include elements other than those shown and described above, such as, by way of example, an additional gateway to prevent or permit movement of the follower 342 along the slot 344. It should also be appreciated that many of the components may be altered, such as, for example, the size of the springs to increase or decrease the spring bias and the load required to move the door 32 beyond ninety degrees.

There are a plurality of advantages from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A home appliance comprising:
an oven,
a door positioned at the front of the oven,
a hinge housing secured to the door and pivotably coupled to the oven, the hinge housing being configured to move the door about a first axis,
a rod pivotably coupled to the oven at a first end, the rod having a second end spaced apart from the first end,
a shear pin securing a collar to the second end of the rod, and
a helical spring compressed between the collar and the hinge housing, the helical spring being configured to exert a shear force on the collar and the shear pin,
wherein (i) the shear force exerted by the helical spring is increased as the door is moved about the first axis, and (ii) the shear pin is configured to fracture when the door is moved to a predetermined position about the first axis.

2. The home appliance of claim 1, wherein the door is moved to the predetermined position when a load exceeding a predefined overload threshold is applied to the door.

3. The home appliance of claim 1, further comprising:
a lower frame having a number of downwardly extending legs configured to contact a floor,
a housing extending upwardly from the lower frame, the housing having the oven secured thereto and a mounting slot positioned adjacent to the oven, and
a hinge plate extending from a first end to a second end, the first end being received in the mounting slot and the second end being pivotably coupled to a lower end of the hinge housing at a first pivot joint, the first pivot joint having the first axis extending therethrough.

4. The home appliance of claim 3, wherein the door is moved into contact with the floor upon fracturing of the shear pin.

5. The home appliance of claim 3, wherein the first end of the rod is pivotably coupled to the second end of the hinge plate at a second pivot joint spaced apart from the first pivot joint, the second pivot joint having a second axis extending therethrough parallel to the first axis.

6. The home appliance of claim 5, wherein the rod is pivoted about the second axis as the door is moved about the first axis.

7. The home appliance of claim 1, wherein:
the rod extends outwardly from an upper end of the hinge housing such that the second end of the rod is positioned outside of the hinge housing, and
the second end of the rod is moved toward the upper end of the hinge housing as the door is moved about the first axis.

8. The home appliance of claim 7, wherein when the second end of the rod is moved toward the upper end of the hinge housing the helical spring is additionally compressed between the collar and the upper end of the hinge housing.

9. The home appliance of claim 1, wherein the rod is configured to pivot about a second axis extending parallel to the first axis, and the pivoting of the rod about the second axis causes the second end of the rod to move in relation to an upper end of the hinge housing.

10. A home appliance comprising:
an oven,
a door positioned at the front of the oven,
a hinge housing secured to the door at an upper end and pivotably coupled to the oven at a lower end, the hinge housing being configured to move the door about a first axis,
a rod moveably coupled to the hinge housing,
a shear pin securing a collar to the rod, the shear pin being configured to fracture when a predefined shear force is applied to the collar, and
a helical spring extending between the collar and the upper end of the hinge housing, the helical spring being configured to exert a shear force on the collar and the shear pin,
wherein when the door is moved to a predetermined position about the first axis the helical spring exerts the predefined shear force on the shear pin.

11. The home appliance of claim 10, wherein the fracturing of the shear pin allows the door to move freely about the first axis.

12. The home appliance of claim 10, wherein the door is moved to the predetermined position when a load exceeding a predefined overload threshold is applied to the door.

13. The home appliance of claim 10, wherein:
an angle is defined between the door and the front of the oven as the door is moved about the first axis, and
the angle is greater than 90° when the door is moved to the predetermined position.

14. The home appliance of claim 13, wherein the rod is configured to retract into the hinge housing when movement of the door about the first axis causes the angle defined between the door and the front of the oven to increase.

15. The home appliance of claim 14, wherein:
the rod is configured to pivot about a second axis extending parallel to the first axis as the door is moved about the first axis, and
the pivoting of the rod about the second axis causes the rod to retract into the hinge housing as the angle defined between the door and the front of the oven is increased.

16. The home appliance of claim 14, wherein the retraction of the rod into the hinge housing causes the helical spring to compress between the collar and the upper end of the hinge housing.

17. A home appliance comprising:
a housing,
an oven secured to the housing,
a door positioned at the front of the oven, and
a hinge assembly configured to move the door about an axis, the hinge assembly comprising:
a hinge housing secured to the door and pivotably coupled to the housing,
a rod pivotably coupled to the housing, the rod extending outwardly from an upper end of the hinge housing,
a shear pin securing a collar to the rod, and
a helical spring is positioned between the collar and the upper end of the hinge housing, the helical spring being configured to be compressed and exert a shear force on the collar and the shear pin as the door is moved about the axis,
wherein when the door is moved to a position where the angle formed between the door and the front of the oven is greater than 90° the shear pin is configured to fracture from the shear force exerted by the compression of the helical spring.

18. The home appliance of claim 17, wherein the door is moved into contact with the floor upon fracturing of the shear pin.

19. The home appliance of claim 17, wherein:
the hinge assembly further comprises a hinge plate secured to the housing,
the hinge housing is pivotably coupled to the hinge plate at a first pivot joint having the axis extending therethrough, and
the rod is pivotably coupled to the hinge plate at a second pivot joint spaced apart from the first pivot joint.

20. The home appliance of claim 17, wherein the door is moved to the position where the angle formed between the door and the front of the oven is greater than 90° when a load exceeding a predefined overload threshold is applied to the door.
